(19) United States
(12) Patent Application Publication
(10) Pub. No.: US 2025/0241222 A1
(43) Pub. Date: Jul. 31, 2025

(54) Automatic Camera Position Calibration

(71) Applicant: Ag Leader Technology, Inc., Ames, IA (US)

(72) Inventors: Trent Anagnostopoulos, Ankeny, IA (US); Josue Calderon, Apex, NC (US)

(73) Assignee: Ag Leader Technology, Inc., Ames, IA (US)

(21) Appl. No.: 19/041,749

(22) Filed: Jan. 30, 2025

Related U.S. Application Data
(60) Provisional application No. 63/626,717, filed on Jan. 30, 2024.

(51) Int. Cl. A01B 69/00; A01B 69/04; G03B 29/00; G06T 7/73; G06T 7/80

(52) U.S. Cl. CPC A01B 69/001; A01B 69/008; G03B 29/00; G06T 7/73; G06T 7/85; G06T 2207/30252

(57) ABSTRACT

A method and system for self-calibration of camera position on an agricultural vehicle is provided. The method includes the step of identifying at least one visually identifiable structural feature associated with the agricultural vehicle, each of the at least one visually identifiable structural feature having a known pose relative to a coordinate system. The method further includes the step of acquiring imagery with a camera mounted to the agricultural vehicle. The method further includes the step of processing the imagery at a computing device in operative communication with the camera, the imagery comprising the at least one visually identifiable feature, wherein the processing the imagery obtains depth information using the known pose of each of the least one visually identifiable feature and determines a pose of the camera, wherein the pose of the camera comprises a set of rotational offsets and a set of translational offsets relative to the agricultural vehicle.

### RELATED APPLICATIONS

The present application claims priority to U.S. Provisional Patent Application No. 63/626,717, filed Jan. 30, 2024, and entitled, “Automatic Camera Position Calibration”, hereby incorporated by reference in its entirety.

### BACKGROUND

Cameras are omnipresent and used on mobile platforms for many uses such as automatic guidance or to collect information about the environment. It is necessary to know the position of the camera relative to the vehicle, implement, device or space it is mounted on or in so that visually identified objects of interest can be localized in 3D space. The localization may be in a relative space or some global coordinate system such as geodetic coordinates. This localization is necessary to log, reason about or act upon the objects of interest. Installation and calibration of the pose of these cameras is a challenge requiring precise measurement and purpose-built mounting devices. In some applications this process goes so far as to use laser measuring devices and takes hours to complete. Imperfect mounting, measurements or disturbances can render camera generated data inaccurate. While previous work demonstrates calibrating cameras using known images or checkerboards, they require a stringently well-lit environment and obstructive fiducials that require the user to undergo a specific calibration procedure.

Although the present disclosure is not limited to application of automatic camera position calibration in the context of agricultural vehicles or implements, certain problems are amplified or exacerbated in this context. For example, the width of agricultural vehicles and their attachments or implements may be significant and different operations may be performed along the complete span of the agricultural vehicle, sprayers being one such example. In addition, an agricultural vehicle and its attachments may be performing field operations along a plurality of crop rows. For these reasons, precise measurement may be required and may not be readily achievable using methods discussed in prior art. Therefore, a better method or methods for automatic camera position calibration are needed. Particularly, methods which are convenient for vehicle operators while also being effective.

### SUMMARY

Therefore, it is a primary object, feature, or advantage to calibrate a camera's pose relative to a vehicle or platform on which it is mounted by observing features of the vehicle.

Another object, feature, or advantage is to avoid requiring a user to use only specific mounting locations for a camera which expands mounting options.

Yet another object, feature, or advantage is to avoid costly or cumbersome calibration procedures by performing calibration without user input.

A further object, feature or advantage is to provide calibration methods which are convenient to vehicle operators.

A still further object, feature, or advantage is to calibrate a camera's pose relative to a vehicle it is mounted on in a convenient manner.

Another object, feature, or advantage is to provide vehicle guidance without requiring use of an inertial measurement unit (IMU).

Yet another object, feature, or advantage is to provide for calibration of a camera without needing a checkerboard or other obstructive and large fiducial.

A further object, feature, or advantage is to provide for calibration of a camera in a manner which allows the camera to be placed imprecisely.

A still further object, feature, or advantage is to provide for calibration of a camera that does not require typical calibration procedures to be performed at installation or for maintenance.

One or more of these and/or other objects, features, or advantages will become apparent from the specification and claims that follow. No single embodiment need provide each and every object, feature, or advantage as different embodiments may have different objects, features, or advantages.

According to one aspect, a method for identifying the rotational and translational offset of a vehicle mounted camera relative to vehicle's orientation is provided. The method includes finding visually identifiable features of the vehicle or purposefully placed fiducials on the vehicle to identify which have prior known rotational and translation offsets relative to the vehicle. Three-dimensional vectors from the camera to those fiducials or features are estimated using any method of acquiring depth with a camera, to include stereographic images, an active emission depth sensor, or neural net driven depth estimation. The depth estimation is further used to create a 3D plane covering this found feature extending along its long axis and as wide as its short axis. Those vectors and planes are finally used to estimate the roll, pitch, and heading offset of the camera relative to the vehicle as well as the X, Y, and Z offset from the front and centerline of the vehicle. The combination of these values will be referred to as the pose. These calibrations allow reasoning about the vehicle's position within a visually identified environment.

According to another aspect, a method for self-calibration of camera position on an object is provided. The method includes the step of identifying at least one visually identifiable structural feature associated with the object, each of the at least one visually identifiable structural feature having a known pose relative to a coordinate system. The method further includes the step of acquiring imagery with a camera mounted to the object. The method further includes the step of processing the imagery at a computing device in operative communication with the camera, the imagery comprising the at least one visually identifiable structural feature, wherein the processing the imagery obtains depth information using the known pose of each of the least one visually identifiable structural feature and determines a pose of the camera, wherein the pose of the camera comprises a set of rotational offsets and a set of translational offsets relative to the object. The method further includes the step of performing a control function associated with the object using the imagery and the pose of the camera. The object may be a vehicle such as an agricultural vehicle. The step of processing the imagery may include estimating three-dimensional vectors from the camera to the at least one visually identifiable structural feature within the imagery. The step of processing the imagery may include estimating a 3D plane covering the at least one visually identifiable structural feature within the imagery. The control function may include a guidance function. The method may further include the step of securing a fiducial to the object such that the at least one visually identifiable structural feature comprises the fiducial.

According to another aspect, a method for a vehicle having a front centerline is provided. The method may include steps of identifying at least one visually identifiable structural feature associated with the vehicle, each of the at least one visually identifiable structural feature having a known pose relative to a coordinate system, acquiring imagery with an imaging device mounted to the vehicle, and processing the imagery at a computing device in operative communication with the imaging device, the imagery comprising the at least one visually identifiable structural feature, wherein the processing the imagery obtains depth information using the known pose of each of the least one visually identifiable structural feature and determines a pose of the imaging device, wherein the pose of the imaging device comprises a set of rotational offsets and a set of translational offsets. The method may further include performing an operation based on the imagery and the pose of the imaging device. The operation may be a physical operation such as a field operation performed by the vehicle or an agricultural implement. The depth information may be estimated depth information. The set of rotational offsets may be relative to the vehicle while the set of translational offsets may be relative the front centerline of the vehicle. At least one visually identifiable structural feature may include a hood ornament, a hood crease, a hood vent, a residual, or combinations thereof. Where the structural feature is a residual marker it may include a pole and may be positioned to extend forwardly in alignment with a crop row when the vehicle is engaged in performing a field operation on the crop row. The method may further include steering the vehicle along a path using the pose of the imaging device. The operation may be a vehicle guidance operation, and the method may further include performing a vehicle guidance of the vehicle using the imagery and the pose of the imaging device.

According to another aspect, a system for self-calibration of camera position on a vehicle is provided. The system includes a computing system comprising at least one processor and at least one memory operatively connected to the at least one processor for storing a set of instructions. The set of instructions may be configured to identify at least one visually identifiable structural feature associated with the vehicle, each of the at least one visually identifiable structural feature having a known pose relative to a coordinate system, acquire imagery with an imaging device mounted to the vehicle and process the imagery comprising the at least one visually identifiable structural feature, wherein the processing the imagery obtains depth information using the known pose of each of the least one visually identifiable structural feature and determines a pose of the imaging device, wherein the pose of the imaging device comprises a set of rotational offsets and a set of translational offsets. The instructions may be further configured to perform an operation based on the imagery and the pose of the imaging device.

### BRIEF DESCRIPTION OF THE DRAWINGS

FIG. 1 is a representation of a vehicle with a hood ornament.

FIG. 2 is a representation of a vehicle with a hood crease.

FIG. 3 is a representation of a vehicle with a hood ornament and a hood crease.

FIG. 4 is a representation of a vehicle with a hood ornament.

FIG. 5 is a representation of a vehicle with a hood ornament.

FIG. 6 is an image of a vehicle taken from a camera skewed right and shifted left.

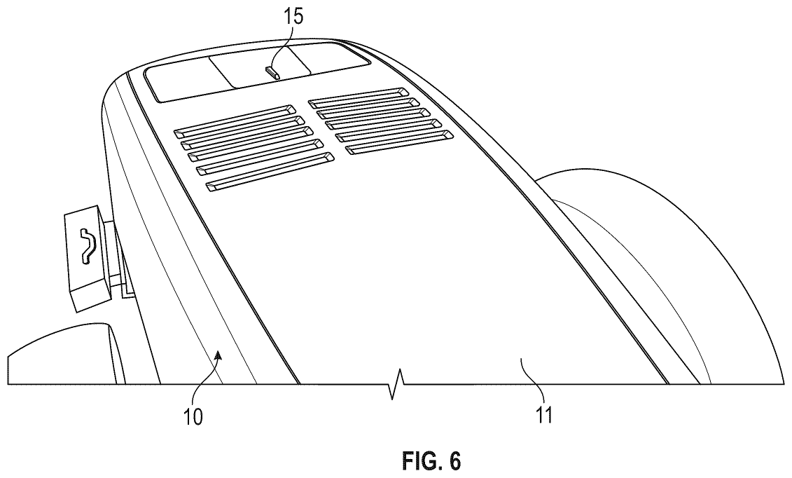

FIG. 7 is an image of a vehicle taken from a camera skewed right, shifted left, and skewed down.

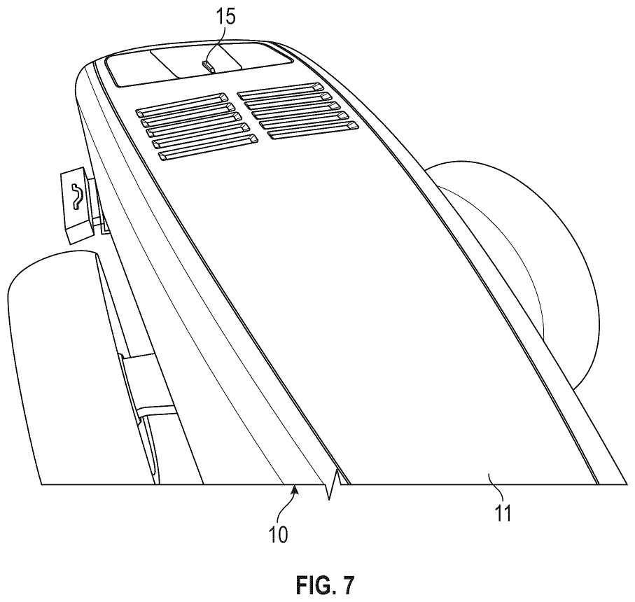

FIG. 8 is an image of a vehicle taken from a camera skewed right, shifted left, skewed down, and rotated left.

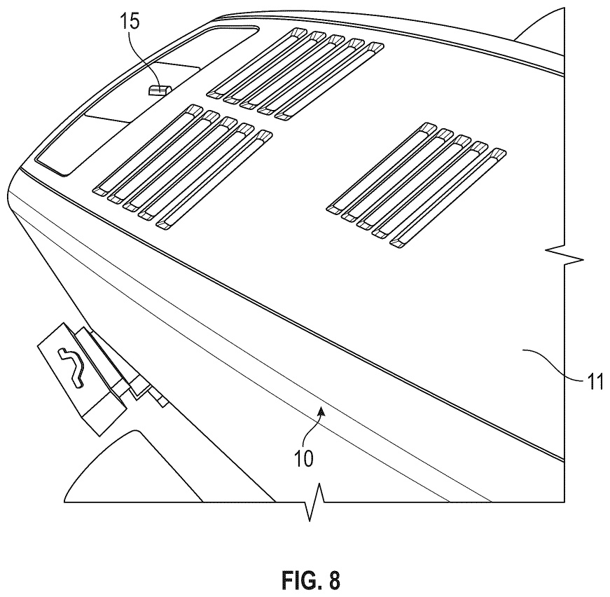

FIG. 9 illustrates a vehicle without visible features.

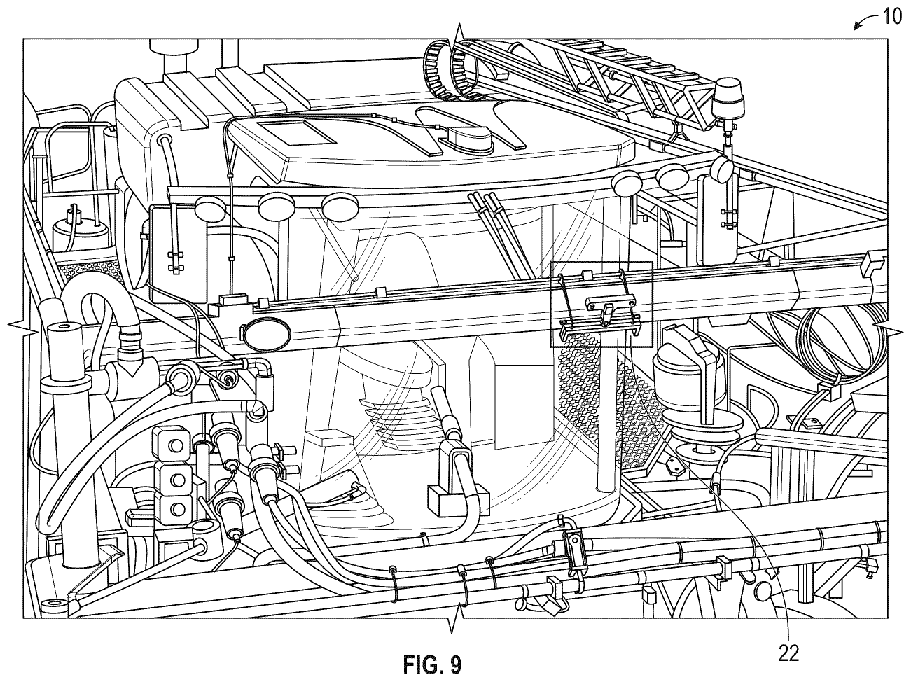

FIG. 10 illustrates a fiducial in the form of a pole having a distinctive color such as pink.

FIG. 11 provides frames of reference defining roll, pitch, yaw, x, y, and x from a top view of a vehicle.

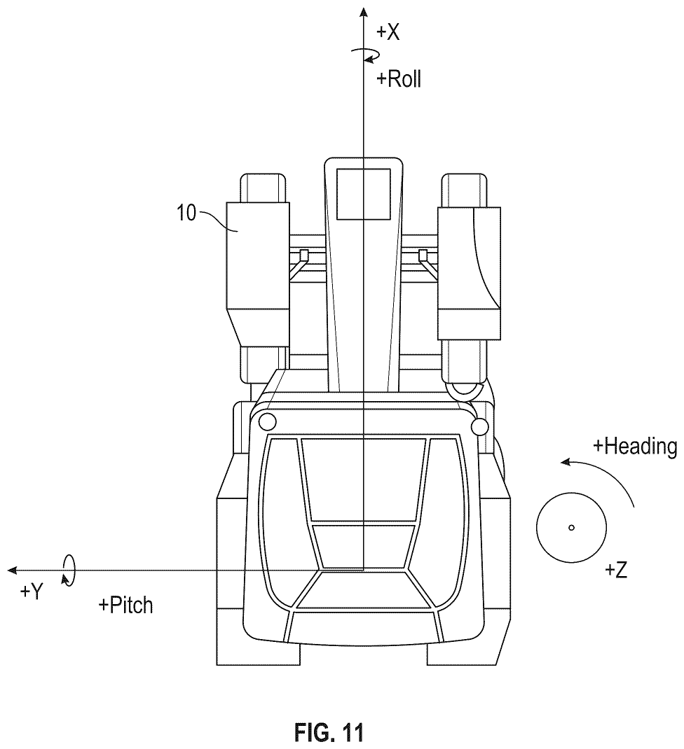

FIG. 12 provides frames of reference defining roll, pitch, yaw, x, y, and z from a side view of the vehicle.

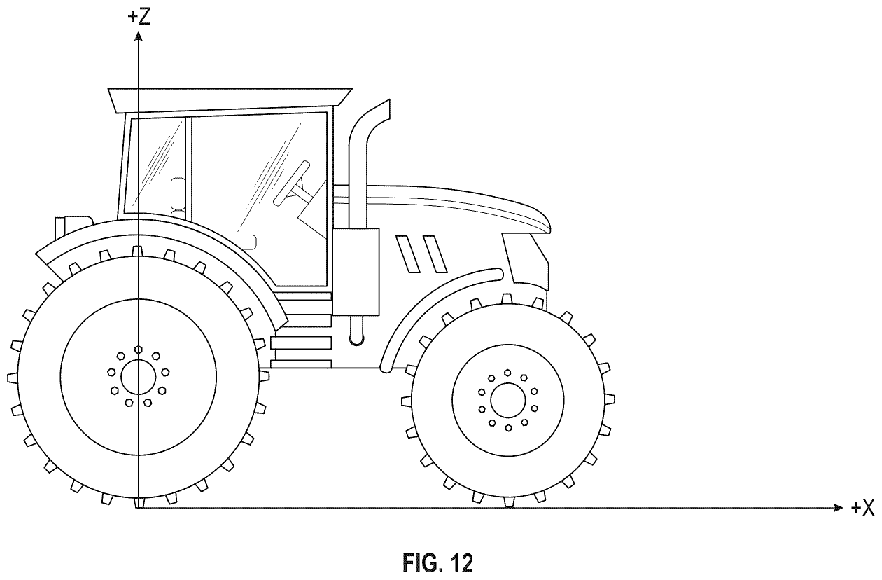

FIG. 13 illustrates a camera reference frame versus a vehicle reference frame.

FIG. 14 illustrates a relationship between camera pixels and angles.

FIG. 15 illustrates a hood crease plane.

FIG. 16 illustrates camera heading calibration.

FIG. 17 illustrates camera pitch calibration.

FIG. 18 illustrates camera roll calibration.

FIG. 19 is a block diagram of one example of a system.

### DETAILED DESCRIPTION

The present disclosure is directed towards methods, apparatus, and systems to constantly calibrate a camera's pose relative to an object (such as a vehicle or agricultural vehicle) on which the camera is mounted. The calibration is performed by observing features of the object which the camera rides upon. This frees the user from restrictive mounting locations and costly calibration procedures by executing the calibration without their input being required. This is especially beneficial in the context of agricultural where the object is an agricultural vehicle such as a tractor or sprayer, or other type of agricultural vehicle.

First, some known feature of the vehicle must be identified. That feature must have a known offset from the geometric center of the vehicle and a known orientation compared to the forward direction of the vehicle. Then, the camera's position relative to the center of the vehicle and orientation relative to the forward direction of the vehicle can be estimated based on the identified feature and the image data combined with depth per pixel of that image data.

### Feature Identification

According to one aspect, feature identification is provided. Such a process may use any algorithm or combinations of algorithms to detect known features or combinations of features of the vehicle which the camera is mounted on for the purpose of estimating the camera's pose relative to the vehicle. Examples of algorithms which may be used include detecting, extracting, and matching features like edges, corners, or blobs from objects within the images. Such methods may include algorithms such as scale-invariant feature transform (SIFT) or speeded-up robust features (SURF). Other methodologies may include template matching. Alternatively, machine methodologies such as neural networks including convolutional neural networks (CNNs) may be used. Region based methodologies, shape matching and alignment, Hough transforms, or other methodologies are further examples of methodologies which may be sued.

The specific methodologies used may be selected based in part on the specific feature(s) to be identified or other relevant considerations.

### Example Features

### Hood Crease

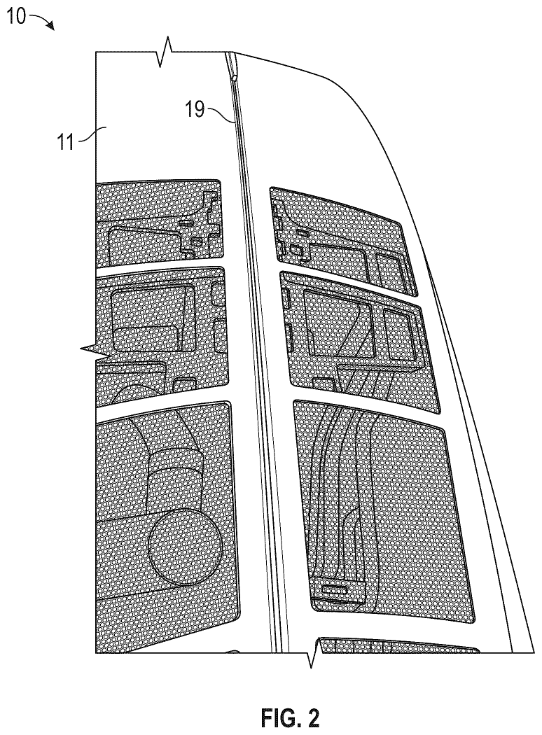

One example of a feature is the hood crease. FIG. 2 illustrates an example of a hood crease 19 such as is commonly found on tractors, which are one type of agricultural vehicle. This crease 19 serves both an aesthetic purpose, as a vehicle body line, and a functional purpose as farmers use this crease to steer down row crops by placing the crease 19 in-between rows. For both purposes, the crease 19 is designed to be geometrically centered between the wheels, straight, and pointing in the direction of travel of the vehicle. A three-dimensional vector from the camera to the hood crease 19 and a plane following along the crease and as wide as the crease 19 allows calculation of the camera's pose.

### Hood Ornament

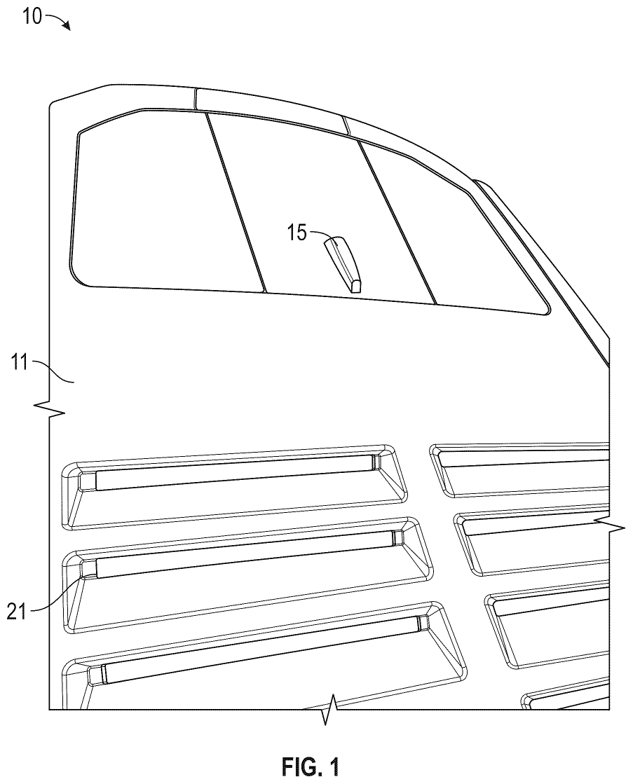

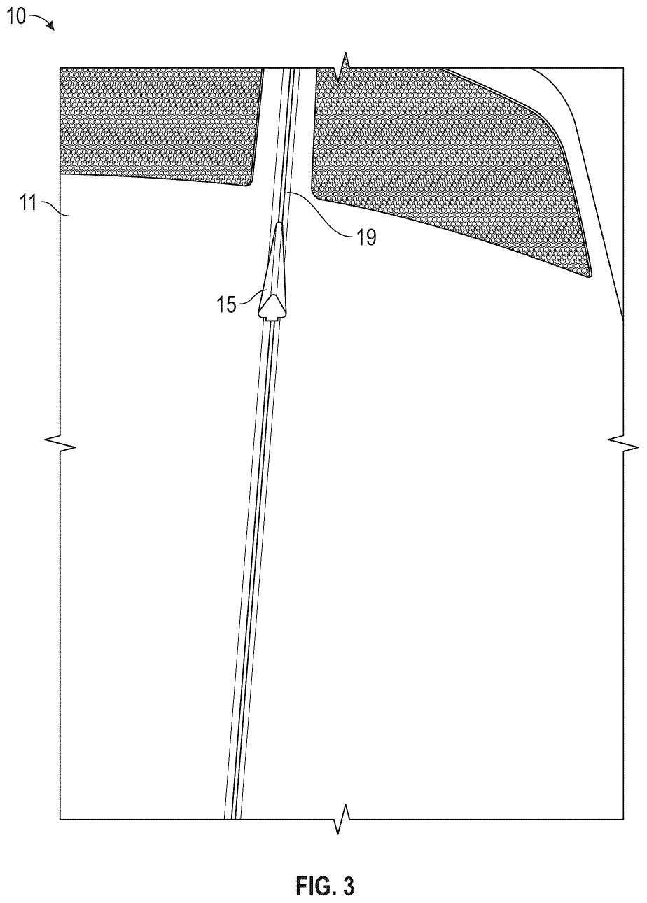

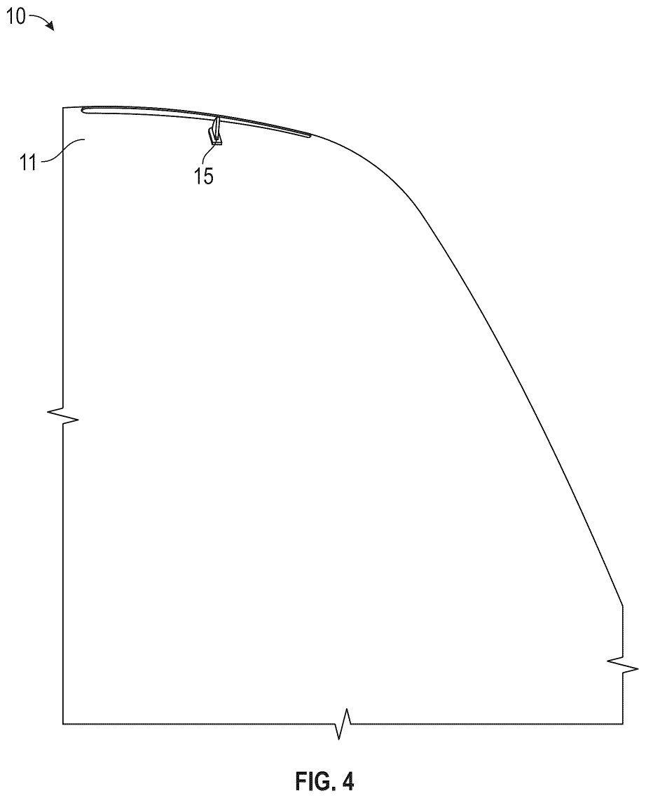

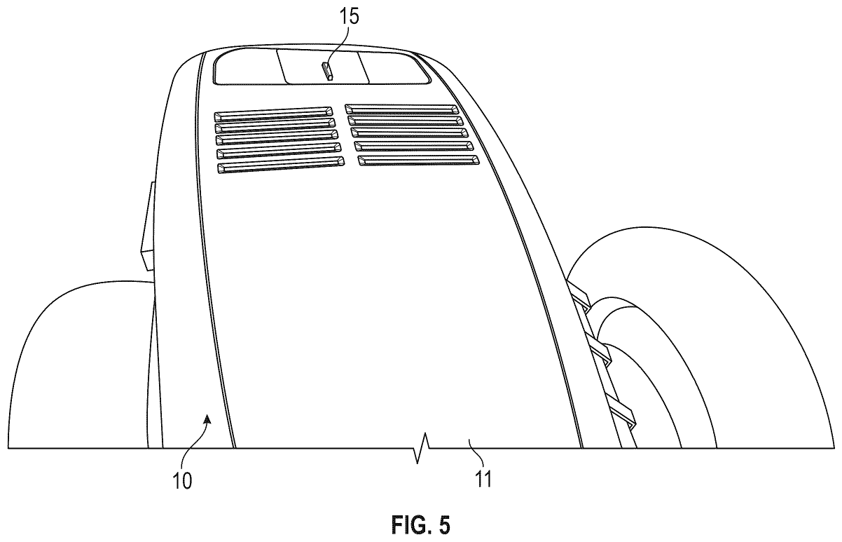

FIG. 1, FIG. 3, FIG. 4, and FIG. 5 show hood ornaments 15 such as may be commonly found on tractors, one type of vehicle 10. FIG. 1 illustrates a hood ornament 15 on the hood 11 of the vehicle 10.

These ornaments are used for similar purposes to the hood crease, and both may exist at the same time such as shown in FIG. 3 where both a hood ornament 15 and hood crease 19 are present. The farmer uses these elongated ornaments to center their vision with the vehicle and orient the tractor between the rows of crop. These ornaments 15 are placed on the center line of the tractor and with its long axis in line with the direction of travel of the vehicle. A three-dimensional vector from the camera to the hood ornament and a plane matching the long axis and short axis of the ornament allows calculation of the camera's pose.

### Hood Vents

FIG. 1 shows a vent structure 21 on the hood 11 that is oriented flat with regards to the vehicle and points in the direction of travel of the vehicle. This feature is not placed for the farmer's use visually, but still provides sufficient reference to generate a 3D plane in the camera's perspective. A three-dimensional vector from the camera to the center of the vents and a plane matching the long axis and short axis of the vents allows calculation of the camera's pose.

### Example Fiducial

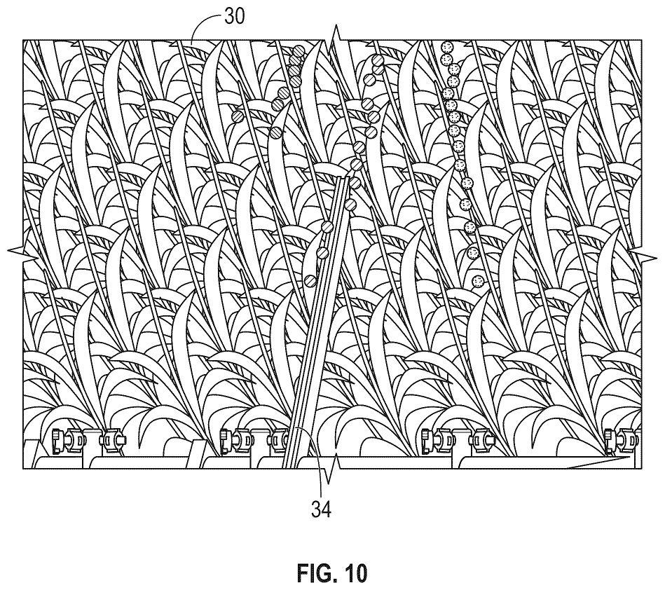

Features can be purposefully added with a known pose relative to the vehicle. FIG. 10 shows an example camera mounting location where no vehicle feature can be seen.

### Pole

FIG. 10 shows an image 30 with a fiducial 34 purposefully placed to serve as a visual identifier of the center line of the vehicle and its direction of travel. The fiducial has a clear directionality and is easy to distinguish visually. These fiducials 34 allow consistent feature identification despite a wide variety of agricultural vehicles. Vehicles such as sprayers will often have no static portion of the vehicle within view of a forward mounted camera. A placed fiducial 34 gives a reference in this event. A three-dimensional vector from the camera to the tip of this fiducial and a plane along the direction of the pole whose width is the width of the pole allows calculation of the camera's pose.

It is contemplated that any number of fiducials may be used. As shown in FIG. 10, the fiducial is in the form of a pole which may be of a distinctive color such as pink. However, a fiducial need not be of a single color, it may be of multiple colors, may provide a distinctive pattern, or may include colors, shapes, or structures which assist in consistent feature identification and may assist in more quickly performing feature identification by reducing or simplifying processing operations required to identify the fiducial. Where the fiducial is easy to distinguish visually and is in view of an operator, the presence of the fiducial may be helpful to a vehicle operator when the vehicle is under manual control.

### Algorithms for Detection

As previously explained, any number of different algorithms or combinations of algorithms may be used for detection.

### Neural Net

In some embodiments neural nets of various designs may be used.

### Object Detection

A neural net algorithm trained to detect and locate known features on agricultural vehicles. For example, an object detection algorithm such as YOLO V8 returns an axially oriented bounding box (AOBB) around the hood ornament. The geometric center of the AOBB will fall on the centerline of the vehicle. The plane following the long axis of the AOBB points in the direction of travel of the vehicle. These two values allow estimating the pose of the camera with respect to the vehicle.

### Pose Estimation

A neural net trained to calculate the pose of the entire agricultural vehicle given what portions are in view of the camera and return its pose. In this context, pose can be the X, Y, Z, roll, pitch, and yaw as described before but also describe further features such as wheel position. Pose estimation requires finding the object in question and finding its center and heading with reference to a coordinate frame. Choosing the camera view frame as the coordinate frame for pose estimation, the results give a 3D plane to the center line of the vehicle and the vehicle's direction of travel. These two values allow estimating the pose of the camera with respect to the vehicle.

### Camera Pose Estimator

A neural net trained by annotating images from various camera mounting positions on an agricultural vehicle with the camera's pose with respect to the vehicle obtained by hand measurement. The resulting neural net natively outputs the camera's pose from the camera's view. This differs from the previous pose estimation in that the neural net does not output a plane along the direction of the tractor used to calculate the pose of the camera but instead the final calibration values of the camera directly.

### Edge Detection

Linear features, such as the hood crease, can be located using classic edge detection algorithms. These algorithms combine a vertical and horizontal Sobel derivative, effectively a rate of change of color, to detect edges in images. Filtering out horizontal edges will leave three major vertical edges when viewing a tractor hood. Those three edges are the left edge of the hood, the crease, and the right edge of the hood. Choosing the center of those three edges identifies the hood crease. The edge gives a plane in the direction of travel of the vehicle and the middle point of the crease edge represents the center line of the vehicle. These two values allow estimating the pose of the camera with respect to the vehicle.

### Color Thresholding

Unique colors that stand out from the rest of the vehicle and the environment can be separated by selecting only the pixels matching the unique color. Fiducials can be added with unnatural colors, such as magenta, allowing them to be easily found and not accidentally selecting pixels that are not part of the fiducial. Existing features may also have unique colors, such as emblems.

### Camera Pose Estimation

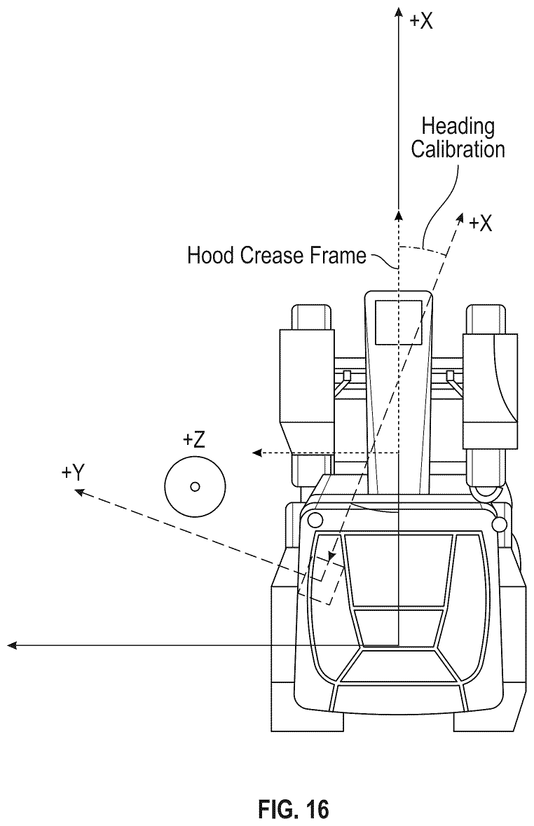

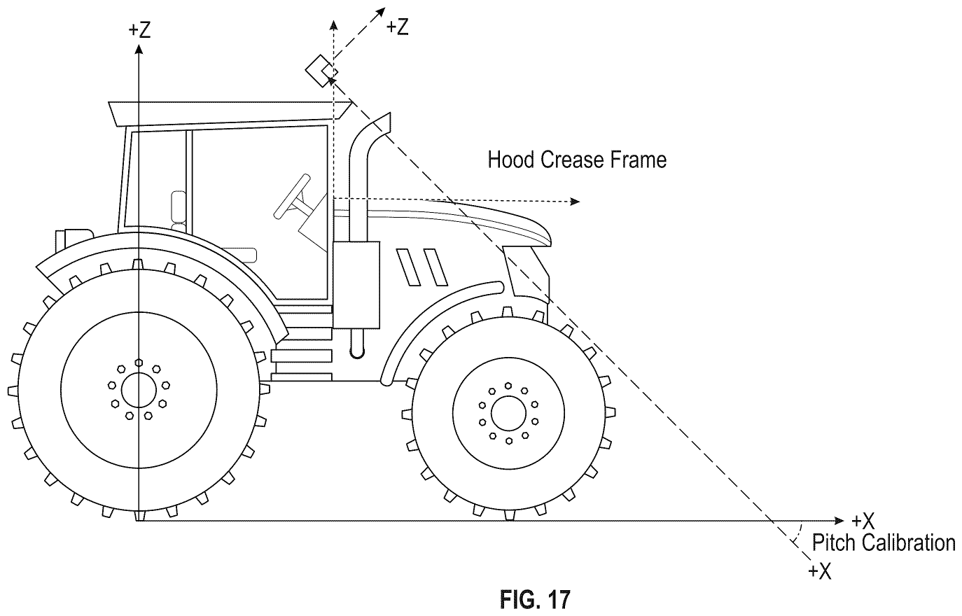

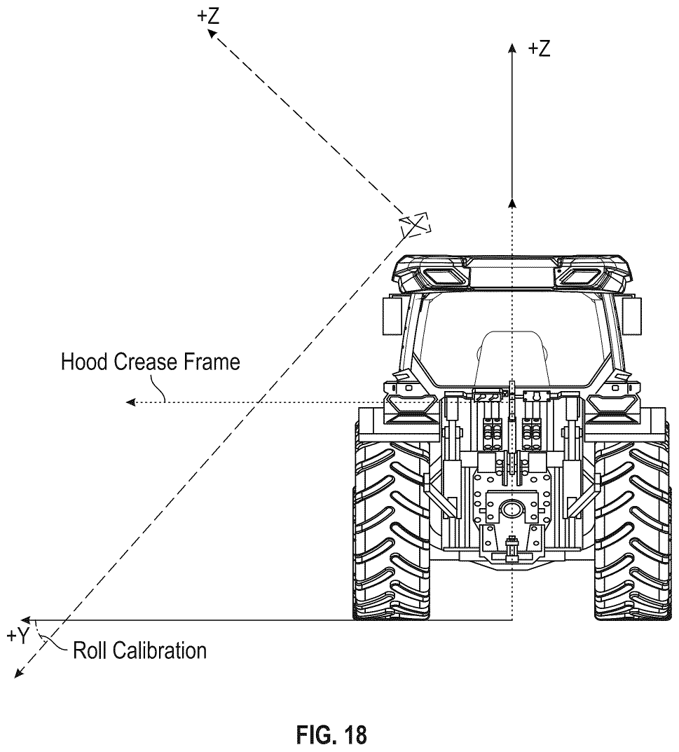

This process assumes a feature, with a known offset from the geometric center of the vehicle and a known orientation relative to the front facing direction of the vehicle, has been found. The pixel location and depth data for pixels in which the feature resides are used to find the feature's position and orientation in 3D space relative to the camera. Finally, the camera's pose is estimated knowing the feature's pose relative to the camera and the pre-knowledge of the feature's pose relative to the vehicle. FIG. 16, FIG. 17, and FIG. 18 further illustrate. As shown, the feature may be in the form of a hood crease. As shown in FIG. 16, heading calibration may be performed. As shown in FIG. 17, pitch calibration may be performed. As shown in FIG. 18, roll calibration may be performed.

### Converting Pixel Coordinates to Angles

A camera sensor outputs its data in pixel coordinates. These coordinates have a defined origin, usually at the top left of the image, and describe the image as a grid with each cell referenced by an X and Y coordinate combination. For calibrating the camera position, it is necessary to convert the width of a pixel to an angle in physical space. In some embodiments, this process involves using the physical distance separation between the photoreceptors of the camera and information about its lens to convert each pixel to a sweep of degrees in physical space.

In a simple form, the angle of view can be determined. Then the angle of view can be divided by the number of pixels to provide the degree per pixel. Then for a specific pixel coordinate, a position (in pixels) may be multiplied by the degree per pixel value to convert to physical space degrees. Of course, it is to be understood that methodologies may take into consideration the specific camera or other imaging device. Different lens distortion models may be applied as appropriate. Different mathematical models may be applied such as a pinhole cameral model, Brown-Conrady Model, or Plumb Bob Model. In some embodiments it is contemplated that a sequence of images may be used in which case motion may be used to extract 3D structural information.

### Combining Pixel Coordinates and Distance to Generate 3D Vectors

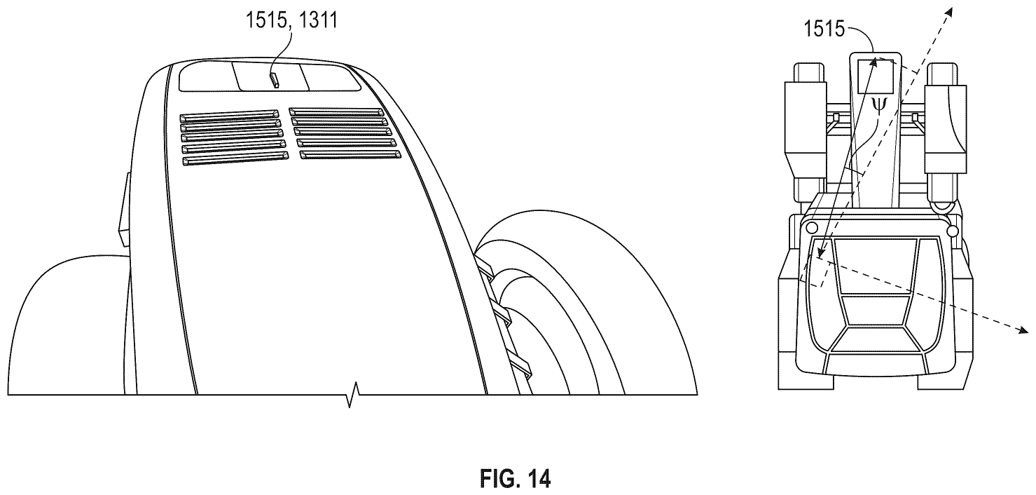

As previously described, each pixel coordinate pair can be converted into two angles emanating from the center of the camera. One angle describing how many degrees a pixel views above or below the camera and the other describing how many degrees left or right the pixel views. The addition of depth information gives the magnitude of a vector pointing from the camera to whatever object a specific pixel is viewing. The combination of this magnitude and the two resulting angles can be converted into a 3D vector using well known means. This allows each pixel to be converted into a 3D vector starting from the center of the image sensor of the camera and through real space to the object the pixel is viewing. FIG. 14 shows the relationship between pixels of a camera and angles in physical space.

### Angular Camera Offset

Identification of the feature requires locating the feature in visual space marking which pixels belong to the feature and which do not. So long as the feature has a known directionality in relation to the vehicle and is visually identified with sufficient pixels to estimate its orientation then a 3D vector traveling along the feature can be calculated by fitting a line to the series of 3D vectors resulting from pixels marked as part of the feature.

### Camera Heading Offset

The 3D vector traveling along the long axis orientation of the feature and is defined in camera relative coordinates can be broken down into three components. The three components are the amount of travel in front or behind of the camera, the amount of travel to the left or the right of the camera, and the amount of travel above or below the camera. A 3D vector can be broken into component angles along the forward/backward and left/right plane and another angle in the up/down plane and the forward/backward plane using well known methods. The forward/backward and left/right plane angle is equivalent to the heading of the vector representing the feature in the camera space.

The found feature has a prior known heading relationship with that of the forward travel direction of the vehicle. The combination of the camera space heading of the feature and its prior known heading in relation to the vehicle's forward direction then the camera's heading in relation to the vehicle's forward direction can be calculated.
Psi_fc=Heading of the feature in camera space
Psi_fv=Heading of the feature in vehicle space
Psi_cam=Heading of the camera in vehicle space

$$Psi\_cam = - Psi\_fc + Psi\_fv$$

For example, If the camera sees the crease feature as pointing 2 degrees to its left then:
Psi_fc=2 degrees

If the hood crease is always centered about the direction of travel:
Psi_fv=0 degrees

Then the camera's heading relative to the vehicle's forward travel is:
Psi_cam=−2 degrees

### Camera Pitch Offset

Referencing the heading offset calculation, we know we can break a vector pointing along the orientation of the feature in 3D space relative to the camera into at least two angles. The forward/backward and up/down angle represents the pitch of the feature in camera space. We can calculate the camera's pitch relative to the vehicle with the following.
Phi_fc=Pitch of the feature in camera space
Phi_fv=Pitch of the feature in vehicle space
Phi_cam=Pitch of the camera in vehicle space

$$Phi\_cam = - Phi\_fc + Phi\_fv$$

For example, if the camera sees the feature having a 2 degree pitch upward:
Phi_fc=2.0 degrees

The hood crease points out towards the horizon:
Phi_fv=0.0 degrees

Then the camera's pitch orientation is:
Phi_cam=−2.0 degrees

### Camera Roll Offset

Roll calibration is unique from heading and pitch calibration because the image remains unchanged as the camera rolls about its forward axis. Further, if the camera is rotated beyond +/−89 degrees, where 0 degrees means flat in regard to the vehicle and the bottom pixel of the camera pointing down towards the vehicle, then an aliasing issue makes it impossible to detect which direction the camera rolled and if the observed feature is in a different position or the camera is rolled. Therefore, this method is restricted to camera installations that are within +/−89 degrees.

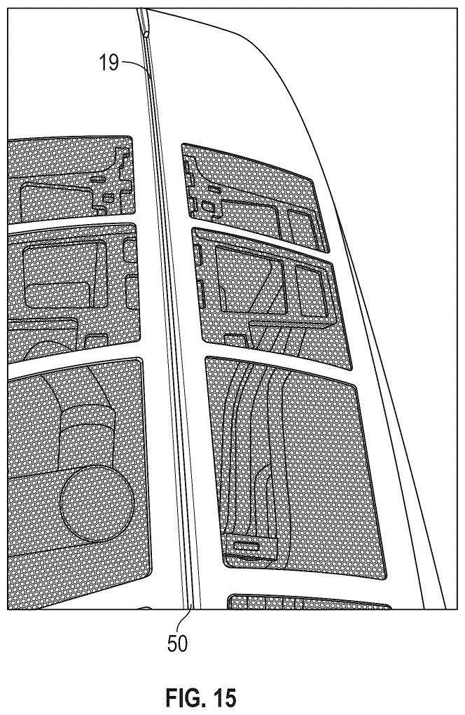

The process requires identifying a feature on the vehicle which is planar. The previously described hood crease defines a plane by the width of the crease and the hood ornament describes a plane by the bounding box that contains its long and short axis. The 3D location of this plane can be estimated in camera space by taking each pixel coordinate pair marked as part of the feature, turning that pixel coordinate pair into angles and adding depth to find each pixel's location in 3D space. FIG. 15 illustrates one such example where a plane 50 associated with the hood crease 19 is shown.

Once the 3D plane is estimated in camera space, we can apply a pose computation algorithms to find the roll of the camera. One example of a pose computation algorithm is the Perspective-n-Point (PnP) pose computation such as implemented in the OpenCV library of programming functions for real-time computer vision.

### Translation Offset

The previous methods described identifying a feature or fiducial on the vehicle. Identification includes sufficient knowledge to calculate the visual center of the feature. The visual center means the centroid x and y pixel of the object as viewed by the camera. Identifying the feature also includes knowing the position of that feature relative to the vehicle. For example, the crease of the hood is known to be geometrically centered on the vehicle.

The previous processes allow us to find a 3D vector from any pixel coordinate pair to the object that pixel is observing. This means we can generate a 3D vector emanating from the center of the visual sensor of the camera to the center of the portion of the feature that is in view.

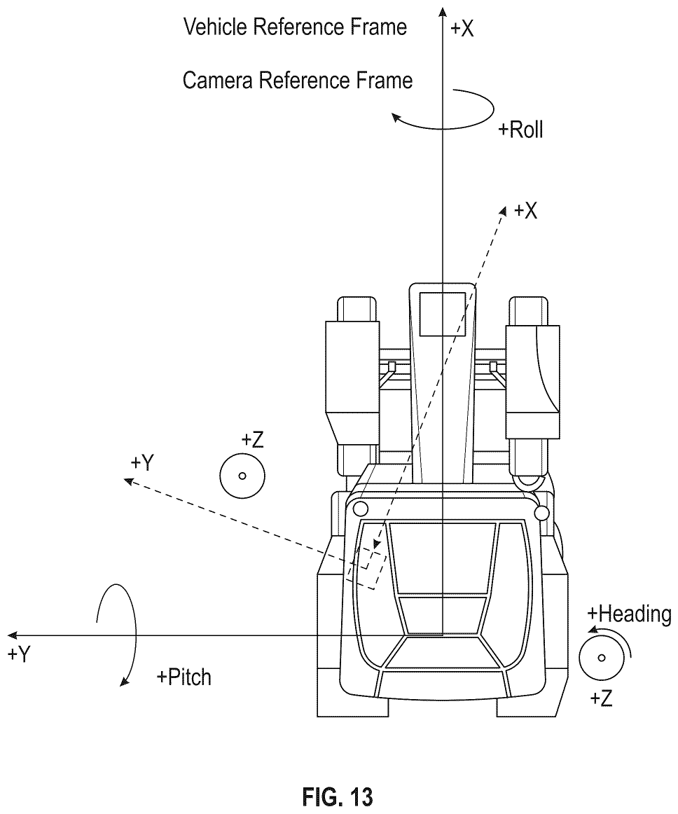

Finally, by combining pre-knowledge of the feature's known position relative to the vehicle we can calculate the translational offset of the camera from the center of the vehicle it rides upon. The feature has known offsets from center Xf, Yf, Zf and we have a 3D vector from the camera to the feature Xc, Yc, Zc then the camera's offset from the centroid of the vehicle is found. FIG. 13 illustrates an example of coordinate systems.

$$Xoffset = Xf + Xc$$

$$Yoffset = Yf + Yc$$

$$Zoffset = Zf + Z c$$

For example, the center of the crease of the hood will have offsets of
Xcrease=−1.5 meters
Ycrease=0 meters
Zcrease=−2.2 meters

If the 3D vector from the camera to the center of the hood crease is
Xcamera_to_crease=0.5 meters
Ycamera_to_crease=−1.0 meters
Zcamera_to_crease=−0.8 meters

Then the camera's position relative to the centroid of the vehicle is
Xcamera_to_vehicle=−1.0 meters
Ycamera_to_vehicle=−1.0 meters
Zcamera_to_vehicle=−3.0 meters

Disclosed are non-exhaustive examples of features or combinations of features that allow the pose to be estimated, algorithms to find those features, and algorithms to identify those features.

Although the terms, imaging device and camera are used throughout, both terms are used to convey that any number of different types of imaging devices or cameras may be used include those which allow for determining depth information. This may include stereo cameras, time-of-flight (ToF) cameras, or other types of cameras. Note that the imaging device or camera need not operate within the visible spectrum but may use electromagnetic waves outside the visible spectrum or non-electromagnetic techniques.

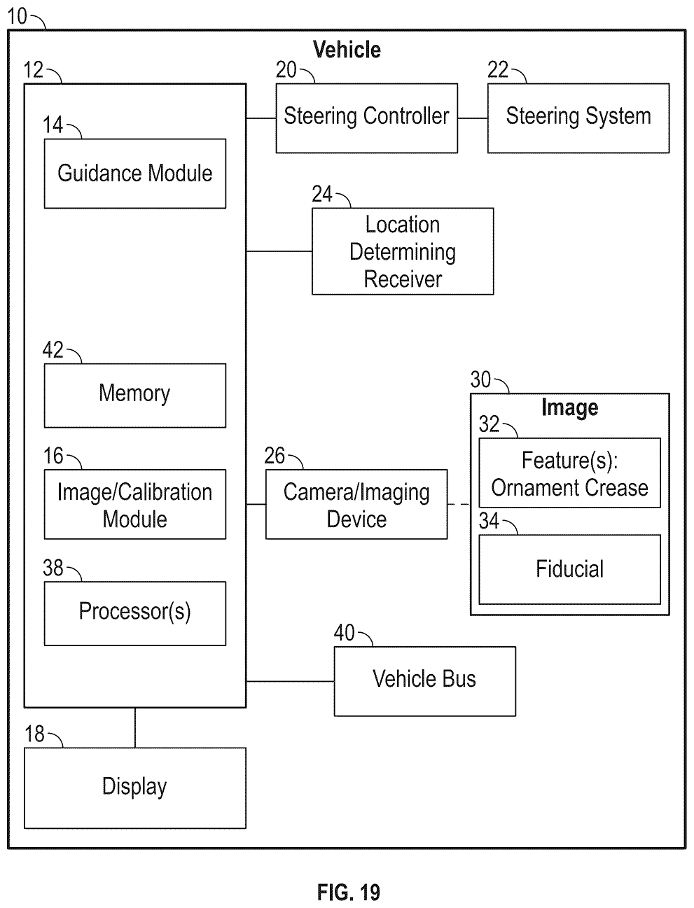

FIG. 19 is a block diagram illustrating one embodiment of a vehicle. The vehicle 10 may have a computing system 12 associated therewith. The computing system 12 may include one or more processors 38. The one or more processors may include one or more microprocessors, microcontrollers, digital signal processors, image processors, mixed-signal processors, or other types of processors. The computing system 12 may also include one or more memories 42 which may be a non-transitory computer readable memory. The computing system may include one or more modules which may be implemented in hardware, software, or a combination of hardware and software. For example, the modules may be implemented in whole or in part using instructions which are stored in the memory 42 and executed on the one or more processors 38. The modules may include a guidance module 14. The guidance module 14 may provide for generating guidance lines or paths and may be operatively connected to a steering controller 20 configured to control the steering system 22 of an agricultural vehicle. In some embodiments, the guidance module 14 may provide guidance information such as to a steering controller 20 or steering system 22 through a vehicle bus 40.

One or more location determining receivers 24 such as GPS receivers may also be operatively connected to the computing system 12 to provide location information such as geospatial information to the computing system 12.

The computing system 12 also has an image and/or calibration module 16. The image/calibration module 16 may be in operative communication with one or more cameras or imaging devices 26. The camera or imaging device 26 may capture imagery 30. Within the imagery 30, one or more features 32 may be present such a hood ornament, hood crease and/or a one or more fiducials 34.

A display 18 may be operatively connected to the computing system 12. The display 18 may be used in any number of ways including to display map information such as for a field area, guidance lines for crops, location information, acquired imagery, or other information. For example, in some embodiments, imagery acquired with the one or more cameras or imaging devices 26 may be displayed to an operator in order to allow the operator to confirm that the camera or imaging device is operating appropriately and the view is not obstructed.

As shown in FIG. 19, imagery 30 including features 32 on the vehicle 10 or otherwise with known poses relative to another coordinate system may be used to obtain depth information along with image data to auto detect the pose of the camera or imaging device 26. Because the position of the camera may be determined, it is not necessary to have strict positioning requirements for the camera or complicated calibration procedures. Note this is advantageous both for simplifying installation as well as maintenance.

It should be understood that the methods and systems shown allow for the ability to steer using a camera. It is contemplated that this vision steering may be performed with or without a GPS or other geolocation device and with or without an inertial measurement unit (IMU).

Although FIG. 19 is shown in the context of guidance, it is to be understood that imagery or other data acquired may be used in any number of different ways for any number of different purposes. Data acquired directly or indirectly from the camera or imaging device 26 and any other data collected from a vehicle or implement such as from other sensors operatively connected to the computing system 12 through the vehicle bus 40 or otherwise may be logged for further analysis, used in control decisions, or making other decisions based on observation of surroundings. This may include, for example, analyzing field map data and to correct it such as to update location information determined at time of planting to location information obtained at a time after crop emergence, to determine potential errors or issues with data, to confirm that an operation is performed, to evidence that an operation was not performed, to control machine operations such as those associated with chemical application based on row or plant location, vehicle position, or otherwise.

Although various examples have been shown and/or described, numerous options, variations, and alternatives are contemplated. For example, instead of mounting a single camera it is contemplated that more than one camera may be present in order to provide redundant views or additional views. In some embodiment, one or more cameras may be mounted on a vehicle and one or more cameras may be mounted on an implement. In some embodiments, one camera may be mounted generally towards the direction of travel while another camera may be mounted in an opposite direction.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more”. Further, as used herein, the article “the” is intended to include one or more items referenced in connection with the article “the” and may be used interchangeably with “the one or more”. Furthermore, as used herein, the term “set” is intended to include one or more items (e.g., related items, unrelated items, a combination of related and unrelated items, and/or the like), and may be used interchangeably with “one or more”. Where only one item is intended, the phrase “only one” or similar language is used. Also, as used herein, the terms “has”, “have”, “having”, or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or”, unless explicitly stated otherwise (e.g., if used in combination with “either” or “only one of”).

What is claimed is:

1. A method for self-calibration of camera position on an agricultural vehicle, the method comprising:
identifying at least one visually identifiable feature associated with the agricultural vehicle, each of the at least one visually identifiable feature having a known pose relative to a coordinate system;
acquiring imagery with a camera mounted to the agricultural vehicle; and
processing the imagery at a computing device in operative communication with the camera, the imagery comprising the at least one visually identifiable feature, wherein the processing the imagery obtains depth information using the known pose of each of the least one visually identifiable feature and determines a pose of the camera, wherein the pose of the camera comprises a set of rotational offsets and a set of translational offsets relative to the agricultural vehicle.

2. The method of claim 1 further comprising performing a control function associated with the agricultural vehicle using the imagery and the pose of the camera.

3. The method of claim 2 wherein the at least one visually identifiable feature is from a set comprising: a hood ornament on the agricultural vehicle, a hood crease of the agricultural vehicle, a hood vent of the agricultural vehicle, a residual marker of the agricultural vehicle, and a pole extending from the agricultural vehicle.

4. The method of claim 3 wherein the control function comprises a guidance function for the agricultural vehicle.

5. The method of claim 1 wherein the processing the imagery comprises estimating three-dimensional vectors from the camera to the at least one visually identifiable feature within the imagery.

6. The method of claim 1 wherein the processing the imagery comprises estimating a 3D plane covering the at least one visually identifiable feature within the imagery.

7. The method of claim 1 further comprising securing a fiducial to the agricultural vehicle such that the at least one visually identifiable feature comprises the fiducial.

8. A method for a vehicle having a front centerline, the method comprising:
identifying at least one visually identifiable feature associated with the vehicle, each of the at least one visually identifiable feature having a known pose relative to a coordinate system;
acquiring imagery with an imaging device mounted to the vehicle;
processing the imagery at a computing device in operative communication with the imaging device, the imagery comprising the at least one visually identifiable feature, wherein the processing the imagery obtains depth information using the known pose of each of the least one visually identifiable feature and determines a pose of the imaging device, wherein the pose of the imaging device comprises a set of rotational offsets and a set of translational offsets; and
performing an operation based on the imagery and the pose of the imaging device.

9. The method of claim 8 wherein the depth information is estimated depth information.

10. The method of claim 8 wherein the set of rotational offsets are relative to the vehicle.

11. The method of claim 8 wherein the set of translational offsets are relative the front centerline of the vehicle.

12. The method of claim 8 wherein the at least one visually identifiable feature comprises at least one of a hood ornament, a hood crease, and a hood vent.

13. The method of claim 8 wherein the at least one visually identifiable feature comprises a residual marker associated with the vehicle.

14. The method of claim 13 wherein the residual marker comprises a pole and is positioned to extend forwardly in alignment with a crop row when the vehicle is engaged in performing a field operation on the crop row.

15. The method of claim 8 further comprising steering the vehicle along a path using the pose of the imaging device.

16. The method of claim 8 wherein the operation is a vehicle guidance operation, further comprising performing a vehicle guidance of the vehicle using the imagery and the pose of the imaging device.

17. A system for self-calibration of camera position on a vehicle, the system comprising:
a computing system comprising at least one processor and a least one memory operatively connected to the at least one processor for storing a set of instructions;
the set of instructions configured to:
identify at least one visually identifiable feature associated with the vehicle, each of the at least one visually identifiable feature having a known pose relative to a coordinate system;
acquire imagery with an imaging device mounted to the vehicle; and
process the imagery comprising the at least one visually identifiable feature, wherein the processing the imagery obtains depth information using the known pose of each of the least one visually identifiable feature and determines a pose of the imaging device, wherein the pose of the imaging device comprises a set of rotational offsets and a set of translational offsets.

18. The system of claim 17 wherein the instructions are further configured to perform an operation based on the imagery and the pose of the imaging device.

19. The system of claim 18 wherein the at least one visually identifiable feature is from a set comprising: a hood ornament, a hood crease, a hood vent, a residual marker, and a pole.
